(19) United States
(12) Patent Application Publication
(10) Pub. No.: US 2004/0207160 A1
(43) Pub. Date: Oct. 21, 2004

(54) Sealing device

(76) Inventors: Markus von Geisau, Mannheim (DE); Uwe Henrich, Hemsbach (DE); Pascal Penoty, Hemsbach (DE)

Correspondence Address: HARNESS, DICKEY & PIERCE, P.L.C., P.O. BOX 828, BLOOMFIELD HILLS, MI, 48303, US

(21) Appl. No.: 10/785,770

(22) Filed: Feb. 23, 2004

(30) Foreign Application Priority Data
Apr. 16, 2003 (DE) 103 17 782.5

(51) Int. Cl. F16J 15/32

(52) U.S. Cl. 277/549

(57) ABSTRACT

A sealing device between a stationary carrier and a rotatable housing with a sealing element fastened to the housing, the element having a multipole ring, a static seal, and a dynamic seal. The carrier is provided with a track ring as opposite surface for the dynamic seal.

### FIELD OF THE INVENTION

The present invention relates to a sealing device that can be inserted between a stationary carrier and a rotatable housing, and is provided with a sealing element fastened to the housing which has a multipole ring, and a static seal, and a dynamic seal.

### BACKGROUND OF THE INVENTION

In DE 195 03 468 C1, a sealing device is described that can be used in a wheel bearing. The wheel bearing makes it possible to provide sealing functions as well as to determine the rotary speed of the vehicle wheel by means of a multipole ring cooperating with a sensor. Sealing devices of this kind have found varied applications.

In DE 195 03 469 C1, a comparable sealing device is described. The difference being that it uses as the multipole ring an intermediate layer which is completely covered by the elastomer employed for sealing purposes.

### SUMMARY OF THE INVENTION

In view of the afore-described prior art, the object of the invention is to provide a sealing device that is of simple design, can be installed with a minimum effort and has a maximum service life.

This objective can be achieved by use of a sealing device provided with a carrier with a track ring as an opposite surface for the dynamic seal. By this approach, the advantageous design of the sealing element with a multipole ring, a static seal, and a dynamic seal is retained, but an improved sealing performance can be achieved by locating the seal not on the carrier itself, but on the opposite surface consisting of a track ring. This opposite surface can be subjected to treatments such as grinding, polishing or the like, so that the dynamic seal is subjected to less wear. Such a procedure per se is known to be used for cassette seals. Cassette seals, however, occupy considerable space and, hence, cannot be used in all cases. By contrast, the seal according to the invention occupies only a small space and, moreover, is readily fastened to the housing or the carrier.

To achieve good sealing action and good protection for the dynamic seal, the track ring is provided with a radially outward directed guard ring. The internal side of this guard ring can at the same time serve as sealing surface for an axially directed sealing lip of the dynamic seal.

The sealing element consists of a supporting ring, with the dynamic seal being attached to a radially inside located part of the ring, and the static seal and multipole ring being disposed on the radially external part thereof. Moreover, the supporting ring can be provided with an axially oriented cylindrical part which is used to fasten the sealing element to the housing. The cylindrical part can be inserted into the opening of the housing, but it is also possible to provide the housing with a sleeve that can be pushed into the cylindrical part.

It is advantageous for a number of fastening methods to use the multipole ring as a static seal between the cylindrical part and the housing or the sleeve. The multipole ring itself is made of a magnetizable elastomeric material. When the multipole ring is also used as a seal, the outer periphery of the ring advantageously consists of an elastomer. In this manner, a soft external periphery is attained which provides better sealing than can be achieved with an elastomeric material containing ferrite particles.

Preferably, the dynamic seal is a lip seal made of an appropriate elastomeric material. The lip seal is disposed on the track ring and provides radial sealing. It is advantageous if the dynamic seal is additionally provided with an axially sealing lip touching the inner side of the guard ring.

The sealing device is readily fabricated, because the two different elastomeric materials used for the dynamic seal and the multipole ring can be made in a single step, namely they can be simultaneously vulcanized onto the supporting ring.

### BRIEF DESCRIPTION OF THE DRAWINGS

The attached drawings refer to several embodiments of the invention.

FIG. 1 is a longitudinal cross-sectional view of a sealing device with an inserted sleeve inside;

FIG. 2 is a view of a sealing device with an enlarged encoder surface; and

FIG. 3 is a view of a sealing device placed into an opening of the housing.

### DETAILED DESCRIPTION OF THE PREFERRED EMBODIMENTS

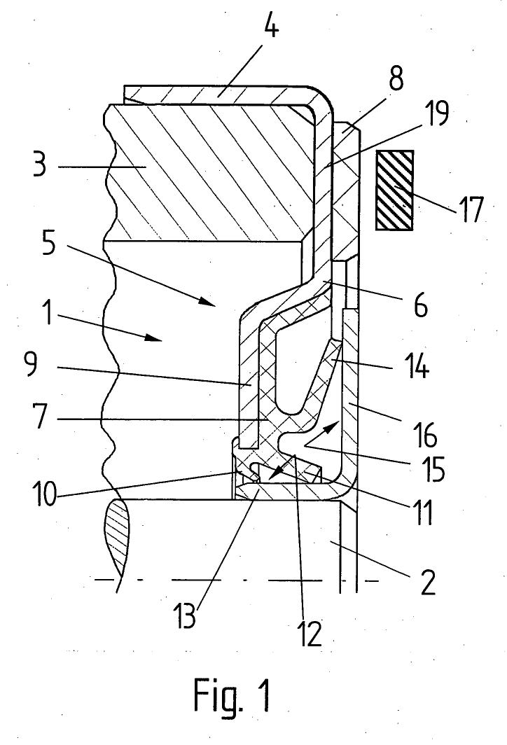

FIG. 1 depicts a sealing device 1 that seals the space between stationary carrier 2 and rotating housing 3. In this case, housing 3 is provided with a sleeve that can be inserted into cylindrical part 4 of sealing element 5. Carrier 2 is a stationary shaft. Sealing element 5, in essence, consists of a metallic guard ring 6 that provides support for dynamic seal 7 and multipole ring 8. Dynamic seal 7 is vulcanized onto the radially internally located part 9 of supporting ring 6. Dynamic seal 7 is also provided with two sealing lips 10 and 11 that are pressed against running surface 12 of track ring 13 that is fastened to carrier 2. Moreover, dynamic seal 7 is also provided with axially sealing lip 14 that touches a protective ring 16 which is oriented radially outward, and forms a unit with track ring 13. The multipole ring 8 is located on the radially externally disposed part 19 of supporting ring 6. Opposite multipole ring 8 is located a sensor 17, wherein a signal corresponding to the rotary speed of housing 3 is generated. Multipole ring 8 itself is made of a magnetizable elastomeric material and is vulcanized onto supporting ring 6.

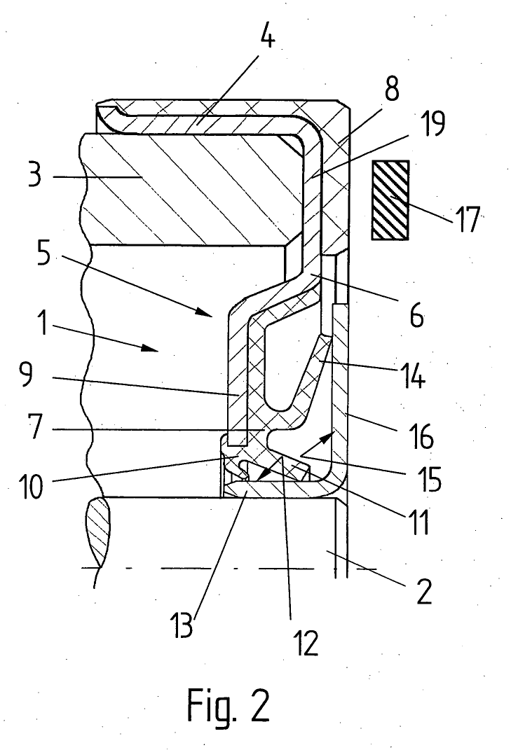

FIG. 2 is a longitudinal cross-sectional view of sealing device 1 of the same design as in FIG. 1. Like reference numerals refer to like elements in FIG. 1. In this case, however, the multipole ring is pulled over cylindrical part 4, which constitutes a simplification from a fabrication standpoint.

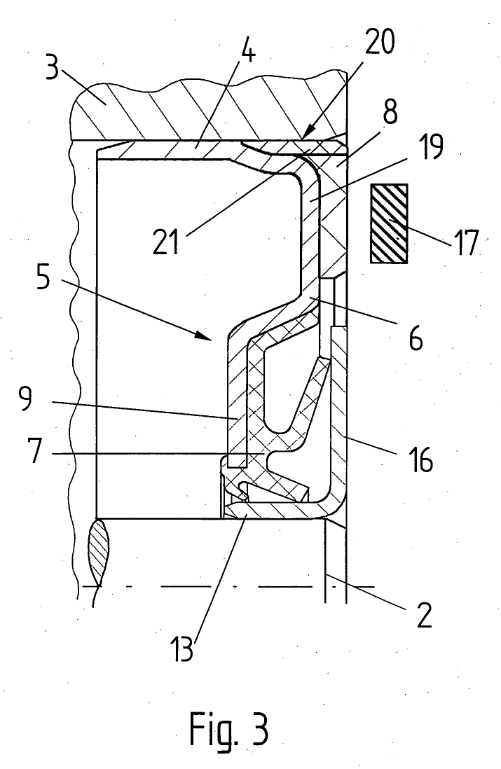

FIG. 3 also contains all essential elements shown in FIG. 1 with the difference being that, here, the multipole ring 8 is used to provide a static seal 20 between cylindrical part 4 of supporting ring 6 and housing 3. In this case, the outer periphery 21 of multipole ring 8 is advantageously made of an elastomer devoid of ferrite particles.

What is claimed is:

1. A sealing device between a stationary carrier and a rotatable housing, comprising a sealing element fastened to the housing and provided with a multipole ring, a static seal, and a dynamic seal, wherein the carrier is provided with a track ring as an opposite surface for the dynamic seal.

2. The sealing device according to claim 1, wherein the track ring has a radially outward directed protective ring.

3. The sealing device according to claim 1, wherein the sealing element comprises a protective ring;
the dynamic seal is disposed on a radially internally located part of the protective ring; and
the static seal and the multipole ring are disposed on a radially outside located part of the protective ring.

4. The sealing device according to claim 3, wherein the protective ring has an axially directed cylindrical part for fastening the sealing element to the housing.

5. The sealing device according to claim 4, wherein the housing has a sleeve that can be inserted into the cylindrical part.

6. The sealing device according to claim 1, wherein the cylindrical part is inserted into an opening of the housing.

7. The sealing device according to claim 4, wherein the multipole ring serves as the static seal between the cylindrical part of the supporting ring and the housing or the sleeve.

8. The sealing device according to claim 1, wherein the dynamic seal comprises a lip seal.

9. The sealing device according to claim 1, wherein the dynamic seal has an axially sealing lip located on an inner side of the protective ring.

10. The sealing device according to claim 1, wherein the multipole ring comprises a magnetizable elastomeric material.

11. The sealing device according to claim 1, wherein an outer periphery of the multipole ring comprises of an elastomer.

12. The sealing device according to claim 11, wherein the elastomer is devoid of ferrite particles.
